(19) United States
(12) Patent Application Publication
(10) Pub. No.: US 2018/0183311 A1
(43) Pub. Date: Jun. 28, 2018

(54) LINEAR MOTOR

(71) Applicant: HIWIN MIKROSYSTEM CORP., Taichung City (TW)

(72) Inventors: Jyun-Ming Luo, Taichung City (TW); Yu-Jung Chang, Taichung City (TW); Bo-Sheng Huang, Taichung City (TW)

(21) Appl. No.: 15/389,585

(22) Filed: Dec. 23, 2016

(51) Int. Cl. H02K 41/02; H02K 5/20; H02K 9/00

(52) U.S. Cl. CPC H02K 41/02; H02K 9/005; H02K 5/20

(57) ABSTRACT

The present invention provides a linear motor, mainly characterized in that a structure for diverting a cooling fluid is disposed on an independent block so as to facilitate processing, and to form an appropriate diversion structure inside the linear motor after assembling, so that a cooling fluid from the outside can be properly diverted into different channels to flow therein.

### BACKGROUND OF THE INVENTION

### Field of the Invention

The present invention relates to a linear motor, and more particularly to a heat dissipation structure of a rotor of a linear motor.

### Description of the Related Art

In order to reduce an impact of thermal energy on operation performance of a linear motor, the conventional solution quickly removes the thermal energy generated by the operation of the linear motor by a flowing fluid to reduce the temperature rising and maintain the performance of the linear motor. Specifically, a stator seat or a rotor seat is provided with built-in or additional means to direct the external fluid into the linear motor such that the maximum heat dissipation effect can be achieved by the flowing fluid.

Different from a driving means of a common rotary motor, a rotor of a linear motor performs linear and reciprocating motion in a certain range. Therefore, when the linear motor is disposed in a machine to function as a driving element, cables for transmitting power, position signals, cooling fluids, or the like need to accordingly move with the rotor of the linear motor, and the cables are integrated at one side of the linear motor through a cable chain, so as to prevent the cables from being damaged.

Therefore, in the prior art, a signal transmission line such as a Hall element for position feedback and a pipeline for conveying a cooling fluid are respectively disposed at two ends of a rotor seat since the interference there between needs to be avoided. However, in this way, if a cable connected to the signal transmission line and the pipeline for conveying the cooling fluid is at a side different from the side of the cable chain, the cable needs to make a detour to the side of the cable chain to be integrated in the cable chain, which requires a detour part of the cable to be appropriately positioned, resulting in inconvenience of installation and arrangement as well as an increase in waste of the length of the cable.

### SUMMARY OF THE INVENTION

Therefore, a main objective of the present invention is to provide a linear motor, which simplifies the arrangement of flow paths for a cooling fluid, simplifies the overall construction, and facilitates integration of cables, so that the linear motor can be more easily disposed in use.

Accordingly, in order to achieve the foregoing objective, the linear motor provided in the present invention is mainly characterized in that a structure for diverting a cooling fluid is disposed on an independent block so as to facilitate processing, and to form an appropriate diversion structure inside the linear body after assembling, so that a cooling fluid from the outside can be properly diverted into different channels to flow therein.

Specifically, the linear motor includes a stator and a rotor. The stator defines a linearly extending guiding direction. The rotor is disposed within the stator, is capable of performing linear and reciprocating motion along the guiding direction, and is provided with a rotor seat and an adapter element, where the adapter element comprises two channels that are respectively disposed on the rotor seat apart from each other. The linear motor is characterized in that the adapter element further includes: a block disposed on the rotor seat; an inflow space disposed in the block; and a diversion space disposed in the block, and communicated with the inflow space and the channels, where in order to be appropriately fitted with the block assuming a block shape, the rotor seat may have a seat, and a notch wherein the notch is recessed in the seat to receive the block.

By means of the combination of the foregoing components, the linear motor disclosed in the present invention is simpler in processing and assembly.

The rotor seat comprises a groove linearly recessed along the seat, wherein the notch comprises a first opening direction and the groove comprises a second opening direction opposite to the first opening direction.

The groove and the notch are in communication with each other.

In a specific diversion structure, the inflow space further comprises an inflow opening formed at a first side of the block, and the diversion space further comprises at least one diversion opening formed at a second side of the block wherein the first side is opposite to the second side, and the diversion opening is in communication with the channels.

In order to minimize the element volume, the adapter element may further include a diversion groove recessed in the second side of the block and the diversion groove comprises a groove body space and a groove opening to define the diversion space and the diversion opening respectively; and the block abuts against the rotor seat through the second side such that the diversion opening is blocked by the rotor seat.

Each of the channels comprises an inlet communicated with the diversion groove.

In addition, the linear motor further includes a sensing element or structure such as a Hall element, disposed at the rotor seat.

### BRIEF DESCRIPTION OF THE DRAWINGS

FIG. 1 is a perspective view according to an embodiment of the present invention.

FIG. 2 is a partially exploded view according to the embodiment of the present invention.

FIG. 3 is a perspective view of a block according to the embodiment of the present invention.

FIG. 4 is a sectional view along a direction 4-4 of FIG. 1 according to the embodiment of the present invention.

FIG. 5 is a sectional view along a direction 5-5 of FIG. 1 according to the embodiment of the present invention.

### DETAILED DESCRIPTION OF THE PREFERRED EMBODIMENTS

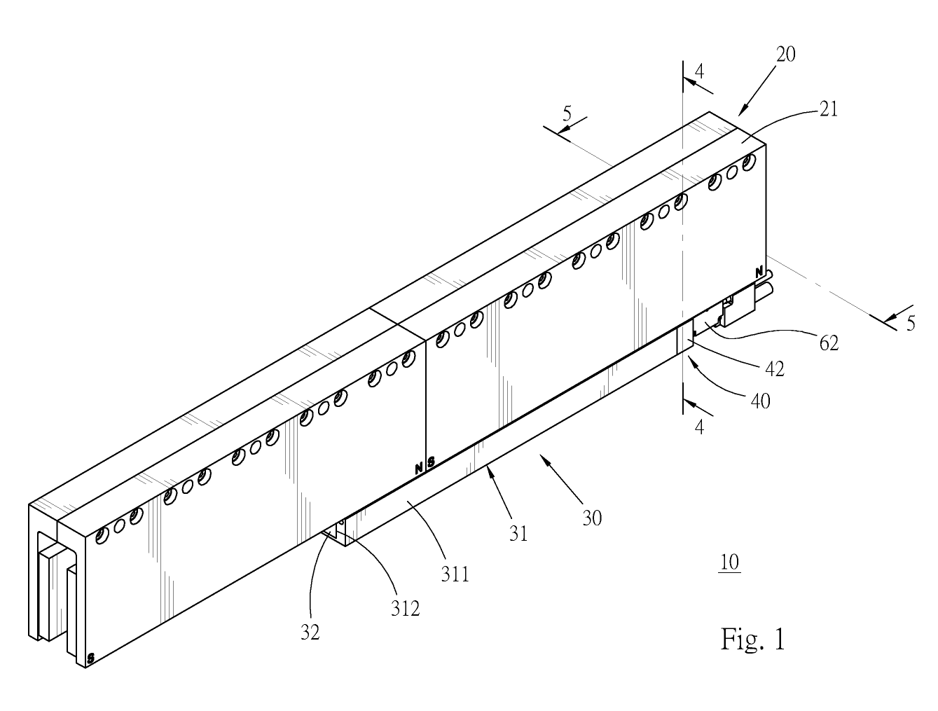

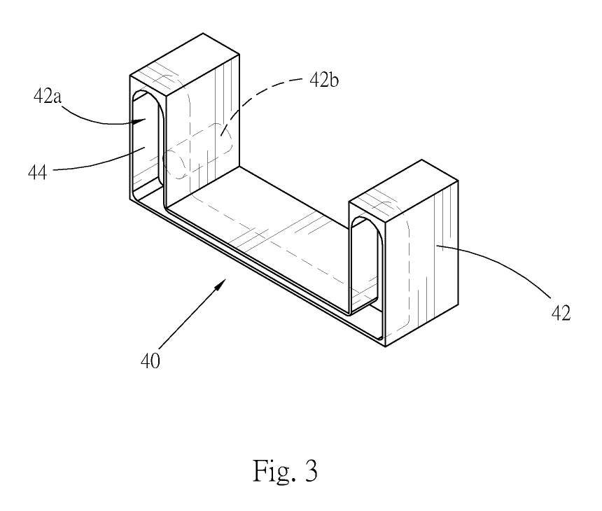

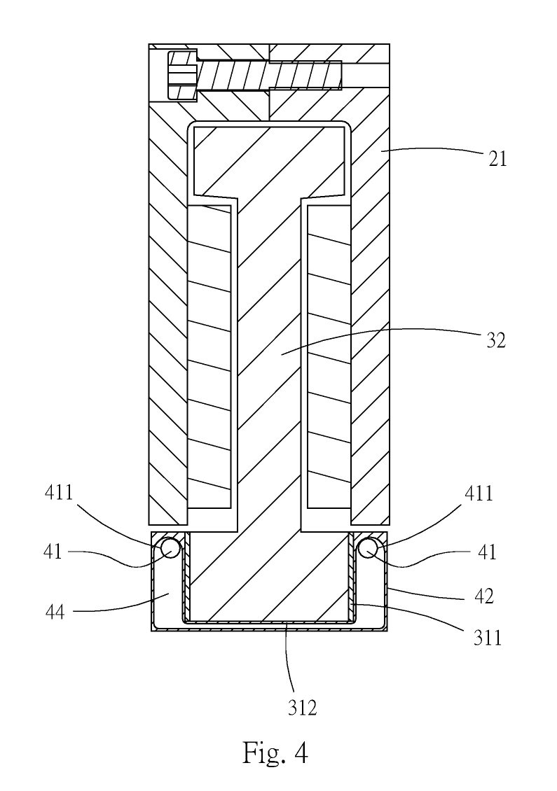

Referring to FIG. 1 to FIG. 5, a linear motor (10) provided in an embodiment of the present invention mainly includes a stator (20), a rotor (30), and an adapter element (40).

The stator (20) and the rotor (30) are secondary side and primary side components of a conventional linear motor, and the rotor (30) performs linear and reciprocating motion on the stator (20) by means of attraction and repulsion effects of a magnetic force. In other words, the technical content required for the reciprocating motion performed by the rotor (30) on the stator (20) falls within the scope of the prior art, and thus are not described herein. However, for easy description of the technical features of the present disclosure, some techniques of the stator (20) and the rotor (30) still need to be described, and thus are stated as follows.

The stator (20) has a stator seat (21) that linearly extends, and an inner space and an opening at a bottom end of the stator seat (21) define a linearly extending guiding direction, so that the rotor (30) performs reciprocating and linear motion along the guiding direction.

The rotor (30) has a rotor seat (31). A rotor portion (32) formed by a plurality of coils is slidably disposed in the inner space of the stator seat (21), and one end of the rotor portion (32) is securely disposed on the rotor seat (31), so that the rotor seat (31) provides support for the rotor portion (32) and also provides a basis for arranging connection elements such as cables or pipelines.

Further, the rotor seat (31) further includes a seat (311), a groove (312), and a notch (313). The seat (311) assumes a long block shape. The groove (312) is recessed in an upper side seat surface of the seat (311) in a manner of linearly extending along a length direction of the seat (311), for the rotor portion (32) to be embedded therein. The notch (313) is provided on a bottom side end surface of the seat (311) and is in direct communication with the groove (312), and extends to two side edges parallel with the length direction of the seat (311).

The adapter element (40) has two channels (41), a block (42), an inflow space (43), and a diversion space (44). The two channels (41) are respectively disposed on the rotor seat (31) apart from each other, and channel ports (411) are respectively formed on end surfaces (314), adjacent to the notch (313), of the seat (311). The block (42) is embedded in the notch (313), and adheres to the end surfaces (314). The inflow space (43) is disposed on the block (42). The diversion space (44) is located in the block (42), and is in communication with the inflow space (43) and the channel ports (411), so as to enable the inflow space (43) to be in communication with the channels (41), whereby an external cooling fluid is entered into the block (42) through the single inflow space (43), and then is diverted by the diversion space (44) to enter the channels (41).

It should be particularly noted that the block (42) may be easily processed to form the inflow space (43) and the diversion space (44), and as compared with the prior art that a hole needs to be drilled on a rotor seat with the required minimum volume so as to form a channel for an external fluid to flow, the independent block (42) is simpler to manufacture and process. For example, in a specific structure disclosed in this embodiment, the block (42) and the notch (313) are complementary in shape for easy assembly, a diversion groove (42a) is recessed at one side of the block (42), a groove body space of the diversion groove (42a) forms the diversion space (44), opened groove openings of the diversion groove (42a) form diversion openings, so as to be in communication with the channel ports (411), and the diversion openings are blocked by the end surfaces (314) of the rotor seat (31), so that the diversion space (44) and the channels (41) are closely joined without a risk of leakage. In addition, a through hole (42b) is drilled at the other side of the block (42), a hole space of the through hole (42b) forms the inflow space (43), one end of the hole is in communication with the diversion groove (42a), and the other end of the hole forms an inflow opening, whereby a cooling fluid supplied from the outside sequentially flows through, via a connection pipeline (61), a flow path including the inflow opening, the inflow space, the diversion space, and the channels, and continuously flows in the rotor seat (31), so as to achieve a heat dissipation effect.

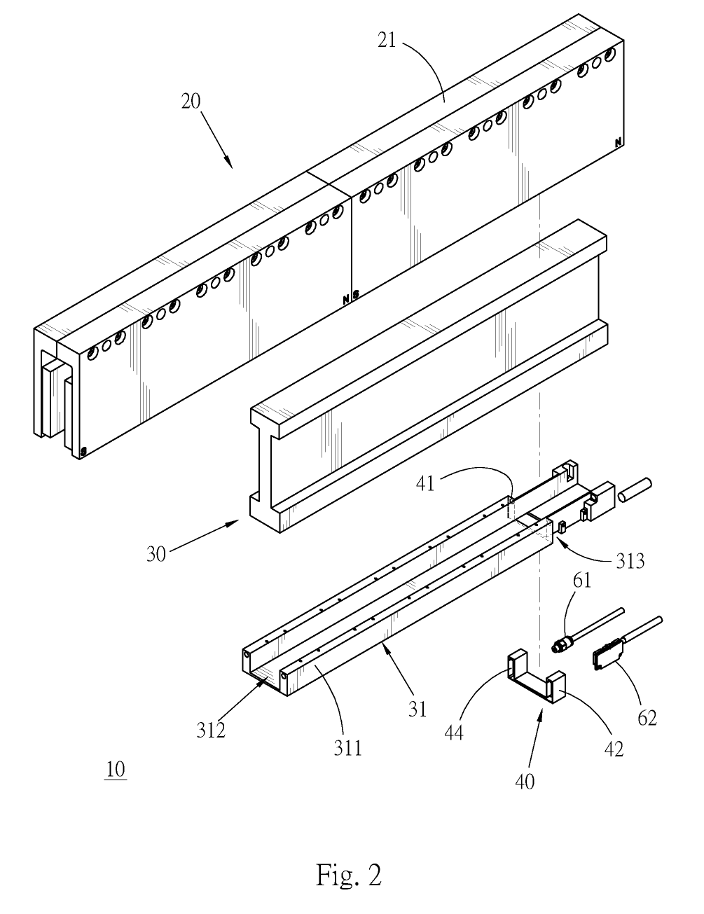

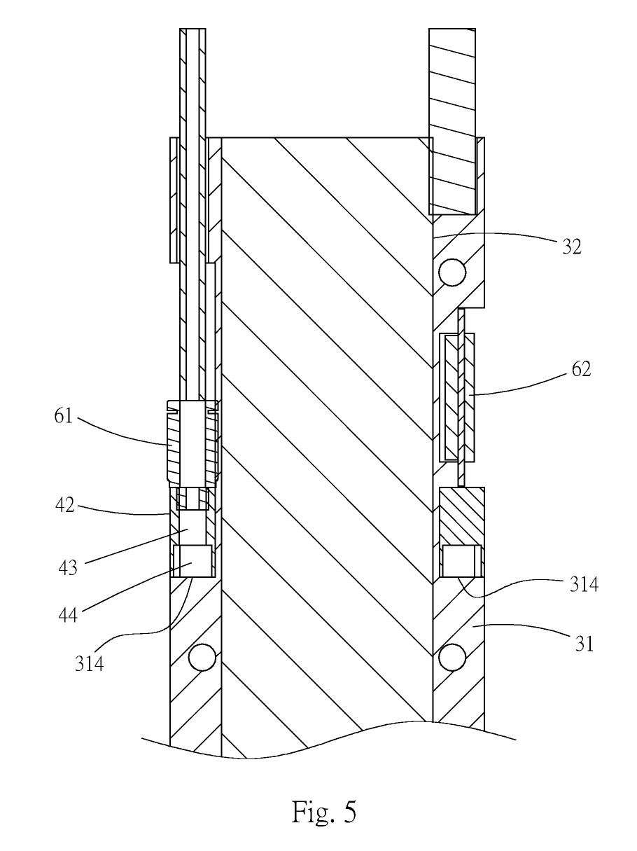

Further, by means of the adapter element (40), an inlet of the cooling fluid is simplified to a single specific structure, so that an effect of simplified pipelines can be achieved in industrial applications of the linear motor. With regard to this, referring to FIG. 1, FIG. 2, and FIG. 5 again, the adapter element (40) merely occupies a space at one side of the rotor seat (31) for arrangement of a pipeline for the external fluid, and therefore, the other side of the rotor seat (31) may be used for arrangement of a sensing structure such as a Hall element (62), so that the pipeline of the cooling fluid and a cable of the sensing structure extend outwards from the same end of the rotor seat (31), thereby avoiding the disadvantage of the prior art, and eliminating redundant lengths of the cable and the pipeline.

In addition, although this embodiment of the present invention discloses that the block is of a block shape, the disclosure is not limited thereto. The main technical feature of the present invention is that a plurality of diversion flow paths or a single flow path for a cooling fluid to flow are/is provided by the external block instead of being directly drilled on the rotor seat, and therefore, variations made to the adapter element with this feature shall fall within the protection scope of the present invention, and the disclosure is not limited to the embodiment disclosed above.

What is claimed is:

1. A linear motor, comprising:
a stator, defining a linearly extending guiding direction;
a rotor, disposed within the stator and comprising a rotor seat to perform linear and reciprocating motion along the guide direction; and
an adapter element, comprising two channels respectively disposed on the rotor seat;
characterized in that:
the adapter element further comprises: a block disposed on the rotor seat; an inflow space disposed in the block; and a diversion space disposed in the block and communicated with the inflow space and the channels; and
the rotor seat has a seat, and a notch wherein the notch is recessed in the seat to receive the block.

2. The linear motor according to claim 1, wherein the rotor seat comprises a groove linearly recessed along the seat.

3. The linear motor according to claim 2, wherein the notch comprises a first opening direction and the groove comprises a second opening direction opposite to the first opening direction.

4. The linear motor according to claim 2, wherein the groove and the notch are in communication with each other.

5. The linear motor according to claim 1, wherein the inflow space further comprises an inflow opening formed at a first side of the block, and the diversion space further comprises at least one diversion opening formed at a second side of the block wherein the first side is opposite to the second side, and the diversion opening is in communication with the channels.

6. The linear motor according to claim 5, wherein the adapter element further comprises a diversion groove recessed in the second side of the block, and the diversion groove comprises a groove body space and a groove opening to define the diversion space and the diversion opening respectively.

7. The linear motor according to claim 6, wherein the block abuts against the rotor seat through the second side such that the diversion opening is blocked by the rotor seat.

8. The linear motor according to claim 7, wherein each of the channels comprises an inlet communicated with the diversion groove.

9. The linear motor according to claim 1, further comprising a sensing element, disposed at the rotor seat.

10. The linear motor according to claim 9, wherein the sensing element is a Hall element.
